(19) United States
(12) Patent Application Publication
(10) Pub. No.: US 2025/0058521 A1
(43) Pub. Date: Feb. 20, 2025

(54) COMPOSITE THREAD CONDITIONING TECHNIQUES

(71) Applicant: Orbital Composites, Inc., Campbell, CA (US)

(72) Inventors: Matthew Gallelo, San Jose, CA (US); Darrell Stevens, Jacksboro, TN (US); Cole Nielsen-Cole, San Jose, CA (US); James Frei, Dixon, CA (US)

(73) Assignee: Orbital Composites, Inc., Campbell, CA (US)

(21) Appl. No.: 18/805,435

(22) Filed: Aug. 14, 2024

Related U.S. Application Data
(60) Provisional application No. 63/532,889, filed on Aug. 15, 2023.

(51) Int. Cl. B29C 64/314; B29C 64/118; B29C 64/209; B33Y 30/00; B33Y 40/10; B33Y 70/10

(52) U.S. Cl. CPC B29C 64/314; B29C 64/118; B29C 64/209; B33Y 30/00; B33Y 40/10; B33Y 70/10

(57) ABSTRACT

A technique for consolidating threads of diverse materials into a cohesive consolidated composite thread that includes a channel with an entry and exit, designed to accommodate threads of both the first and second materials. Equipped with one or more heaters, the technique raises the temperature of the second material above its melting point. A driver propels the threads through the channel, while a thermal conditioner, positioned between the driver and exit of the channel, lowers the temperature of the second material below its melting point prior to entering an extruder nozzle, where it is reheated above the second material below its melting point and deposited onto a 3D printed object.

### CROSS-REFERENCE TO RELATED APPLICATIONS

This application claims the benefit of U.S. Provisional Application No. 63/532,889, entitled “COMPOSITE THREAD CONDITIONING TECHNIQUES,” filed Aug. 15, 2023, which is hereby incorporated by reference in its entirety.

### FIELD

The present disclosure generally relates to additive manufacturing; specifically to devices and methods for consolidating threads into a void-free consolidated composite thread for 3D printing.

### BACKGROUND

Composite materials can offer greater strength, reduced weight, and enhanced versatility than homogeneous counterparts. These composites combine diverse components, often including fibers and polymers, to leverage their respective advantages while mitigating inherent limitations. The process of uniting individual fibers or threads into a continuous, resilient structure is fundamental in developing the composite material with exceptional mechanical properties such as strength, stiffness, and resilience. 3D printing composites encounter difficulties with interlayer adhesion and consistent consolidation, especially when working with dissimilar materials. The layer-by-layer methodology of 3D printing can lead to weak interfaces and insufficient bonding between layers, ultimately impacting the overall performance of the composite. As such, achieving a reliable and uniform thread consolidation between dissimilar materials is desirable.

### SUMMARY

The following presents a simplified summary of one or more embodiments in order to provide a basic understanding. This summary is not an extensive overview of all contemplated embodiments and is intended to neither identify key or critical elements of all embodiments nor delineate the scope of any or all embodiments. Its purpose is to present some concepts of one or more embodiments in a simplified form as a prelude to the more detailed description that is presented below.

In accordance with some embodiments, a device, comprising: a channel with an entrance and an exit, wherein the entrance is configured to receive one or more threads of a first material and one or more threads of a second material; one or more heaters thermally coupled to the channel, wherein the one or more heaters are configured to elevate a temperature of the second material above a melting temperature of the second material; a driver for advancing the one or more threads of the first material and the one or more threads of the second material through the channel; and a thermal conditioner interposed between the driver and the exit of the channel, wherein the thermal conditioner is configured to reduce the temperature of the second material below the melting temperature of the second material.

In accordance with some embodiments, a device, comprising: a channel with an entrance and an exit, wherein the entrance is configured to receive one or more threads of a first material, and wherein at least one thread of the first material is coated with a second material capable of reflow; one or more heaters thermally coupled to the channel, wherein the one or more heaters is configured to elevate a temperature of the second material above a melting temperature of the second material; a driver for advancing the one or more threads of the first material through the channel; and a thermal conditioner interposed between the driver and the exit of the channel, wherein the thermal conditioner is configured to reduce the temperature of the second material below the melting temperature of the second material.

In accordance with some embodiments, a device, comprising: a channel with an entrance and an exit, wherein the entrance is configured to receive one or more threads of a first material; a dispenser connected adjacent to the entrance of the channel, wherein the dispenser is configured to introduce a second material into the channel to coat the one or more threads of the first material; one or more heaters thermally coupled to the channel, wherein the one or more heaters are configured to elevate a temperature of the second material above a melting temperature of the material; a driver for advancing the one or more threads of the first material through the channel; and a thermal conditioner interposed between the driver and the exit of the channel, wherein the thermal conditioner is configured to reduce the temperature of the second material below the melting temperature of the second material.

In accordance with some embodiments, a device, comprising: a channel with an entrance and an exit, wherein the entrance is configured to receive one or more threads of a first material; a dispenser operatively coupled to the one or more threads of a first material, wherein the dispenser is configured to introduce a second material onto the one or more threads of the first material; one or more heaters thermally coupled to the channel, wherein the one or more heaters are configured to elevate a temperature of the second material above a melting temperature of the material; a driver for advancing the one or more threads of the first material through the channel; and a thermal conditioner interposed between the driver and the exit of the channel, wherein the thermal conditioner is configured to reduce the temperature of the second material below the melting temperature of the second material.

In accordance with some embodiments, a device, comprising: a channel with an entrance and an exit, structured to merge one or more threads of a first material and one or more threads of a second material into a single consolidated thread; a vacuum enclosure surrounding the channel, wherein the vacuum enclosure includes at least one inlet and at least one outlet, the inlet accommodates a suction along with the one or more threads of the first material and the one or more threads of the second material, and the outlet accommodates exit of the single consolidated thread and intake of a third material; one or more heaters thermally coupled to the channel, wherein the one or more heaters are configured to elevate a temperature of the second material above a melting temperature of the second material; and a thermal conditioner interposed between the driver and the exit of the channel, wherein the thermal conditioner is configured to reduce the temperature of the second material below the melting temperature of the second material.

In accordance with some embodiments, a method, comprising: advancing, via a driver, one or more threads of a first material and one or more threads of a second material through a channel, wherein the second material is different from the first material; elevating temperature of the second material within the first channel above a melting temperature of the second material; fusing the one or more threads of the first material and the second material within the channel to form a single consolidated thread; and lowering the temperature of the single consolidated thread below the melting temperature of the second material prior to contact with the driver.

In accordance with some embodiments, a method, comprising: advancing, via a driver, one or more threads of a first material through a channel, wherein at least one thread of the first material is coated with a second material capable of reflow; elevating temperature of the second material within the first channel above a melting temperature of the second material; fusing the one or more threads of the first material and the second material within the channel to form a single consolidated thread; and lowering the temperature of the single consolidated thread below the melting temperature of the second material prior to contact with the driver.

In accordance with some embodiments, a method, comprising: introducing, via a dispenser, a second material into a channel; advancing, via a driver, one or more threads of a first material through the dispenser and the channel, wherein the second material is different from the first material; elevating temperature of the second material within the first channel above a melting temperature of the second material; fusing the one or more threads of the first material and the second material within the channel to form a single consolidated thread; and lowering the temperature of the single consolidated thread below the melting temperature of the second material prior to contact with the driver.

### BRIEF DESCRIPTION OF THE FIGURES

For a better understanding of the various described aspects, reference should be made to the description below, in conjunction with the following figures in which like-referenced numerals refer to corresponding parts throughout the figures.

FIG. 1: Illustrates an embodiment of a thread conditioning device where one or more first material threads and one or more second material threads are fused into a single thread composite.

FIG. 2: Illustrates an embodiment of a thread conditioning device separating along the length of the channel into two components.

FIG. 3: Illustrates an embodiment of a thread conditioning device with a void eliminator that fills cross-sectional void regions of the one or more threads of the first material with the second material.

FIG. 4: Illustrates an embodiment of a thread conditioning device with homogenizers that emit sonic, ultrasonic, or mechanical vibrations along the channel.

FIG. 5: Illustrates an embodiment of a vacuum enclosure for the thread conditioning device.

FIG. 6: Illustrates an embodiment of a thread conditioning device with a thread tensioner.

FIG. 7: Illustrates an embodiment of a thread conditioning device with a dispenser that applies particles of a second material onto the one or more threads of a first material.

FIG. 8: Illustrates an embodiment of a thread conditioning device with a dispenser that introduces a second material into the channel.

FIGS. 9A-9B: Illustrate an exemplary flow diagram for merging one or more first material threads and the second material into a single thread composite.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details.

In the context of this disclosure “consolidated” refers to the process of combining or merging multiple threads of a first material such as carbon fiber, fiberglass, or Kevlar along with a second material (thread, filament, pellets, etc.) such as PLA, PEEK, Polycarbonate, or Nylon to form a single, denser and stiffer unit. Consolidation in this sense creates a more robust and uniform structure, as it eliminates voids or gaps between threads of a first material and the second material. The result is a stronger single thread composite that can be precisely deposited onto a 3D object during the printing process, offering improved mechanical properties and enhancing the overall performance of the printed objects.

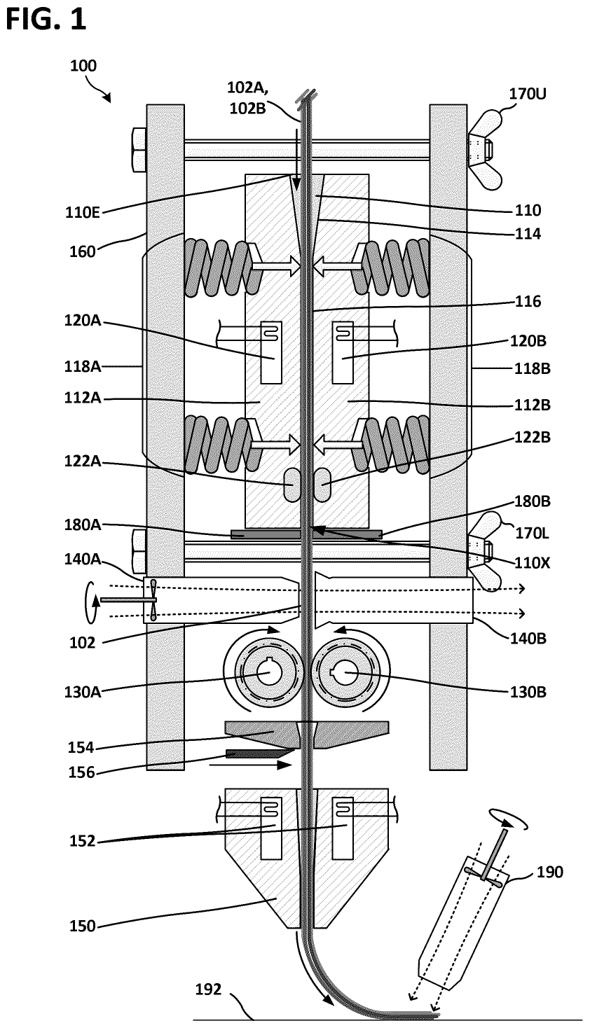

FIG. 1 illustrates an embodiment of a thread conditioning device where one or more threads of a first material 102A and one or more threads of a second material 102B are fused into a consolidated composite thread 102. As depicted in FIG. 1, the thread arrangement 100 includes one or more threads of the first material 102A intertwined with corresponding threads of the second material 102A before entering the channel 110. The channel 110 serves as a pathway for the consolidation process and features a distinct entrance 110E and exit 110X. It is contemplated that the channel 110 acts as the conduit within the thread fusion enclosure plates 112A, 112B, directing the trajectory of the threaded materials during consolidation.

As depicted in FIG. 1, the entrance 110E to the channel is tapered, enabling a smooth transition into the channel 110 for the incoming threads from one or both of the first material spool 102A and the second material spool 102B. The taper design further facilitates the efficient and uniform movement of one or both the one or more thread of the first material and second material threads through the channel 110. In some embodiments, the entrance 110E to the channel is not tapered. For example, it may be advantageous for the channel to maintain a consistent width throughout.

As depicted in FIG. 1, a segment 116 of the channel 110 maintains a constant cross-sectional area. This constant cross-sectional area is positioned adjacent to or just before the channel exit 110X, further enhancing the uniformity of the consolidated thread. It has been noted that this configuration more effectively promotes the seamless integration of the first and second material threads into a cohesive consolidated composite thread 102. In some embodiments, the segment 116 of the channel 110 that maintains a constant cross-sectional area is positioned prior to the exit 110X. In some embodiments, the segment 116 of the channel 110 that maintains a constant cross-sectional area is positioned at the entrance 110E.

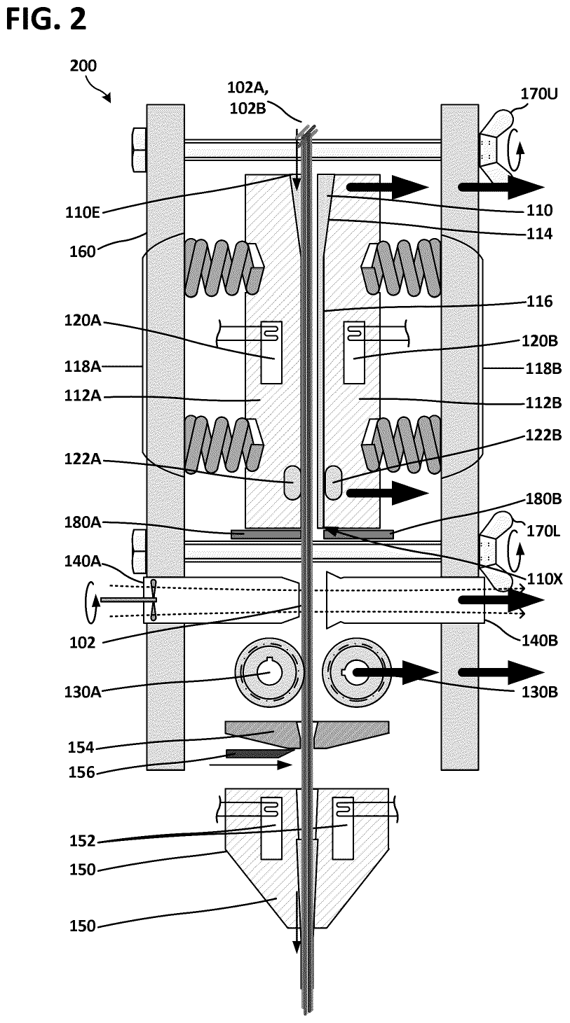

In some embodiments, the channel 110 includes at least one movable wall 114. This design aspect enables the channel 110 to exhibit a dynamic characteristic. For example, FIG. 2 illustrates an embodiment of the thread conditioning device separating along the length of the channel 110 into two components. Unscrewing wing-nuts 170U and 170L, as depicted in the thread arrangement 200 of FIG. 2 provide a simple partitioning mechanism that separates the thread conditioning device into two separate components. It should be appreciated that other partitioning mechanism can be implemented. For example, in some embodiments, the partitioning mechanism implements movement of one or more levers to separate the thread conditioning device into two separate components. In some embodiments, the partitioning mechanism implements rotation of one or more nuts/bolts to separate the thread conditioning device into two separate components. In some embodiments, the partitioning mechanism implements a suspension system such as a rocker-bogie configuration, to ensure controlled movement when separating the thread conditioning device into two separate components.

This partitioning mechanism simplifies the procedure for loading and unloading the threads. The ability to separate the thread conditioning device into two distinct components greatly facilitates access to the interior of channel 110. Streamlined insertion of threads, easier extraction of the consolidated composite thread 102, and simplified removal of any potential clots or material accumulation within the device are key benefits. Incorporating this movable wall 114 enhances the overall efficiency of the device and improves user-friendliness, especially when managing thread materials with diverse compositions.

In some embodiments, the channel 110, the channel entrance 110E, or the channel exit 110X incorporates a threading mechanism designed to facilitate the initial loading of the one or more threads of the first material 102A and the second material 102B. For example, the threading mechanism depicted in FIG. 2 involves detaching plates 112A and 112B from the channel 110. Various alternative embodiments can be employed to achieve efficient and accurate loading of these threads into the channel. Guides or grooves within the channel entrance 110E or channel exit 110X can provide a pathway for the threads, ensuring proper alignment and reducing the risk of tangling or misplacement. Threading pins or hooks near the channel entrance 110E or channel exit 110X may interact with the threads to guide them into the channel in a controlled manner. Strategically positioned pins or hooks help prevent entanglement or friction, ensuring a seamless loading process. Automated or mechanical systems may assist in aligning and inserting the threads with high precision. Additionally, magnetic or electromagnets can be used for threads made from materials responsive to magnetic fields, guiding the threads into the channel entrance 110E for accurate alignment.

In some embodiments, the movable wall 114 demonstrates the ability to finely adjust the cross-sectional area of channel 110 according to specific requirements. Dynamic modulation of the cross-sectional area of the channel applies carefully controlled pressure to the threads, effectively promoting the elimination of voids and facilitating the densification process. This adaptive alteration of the geometry of the channel significantly impacts the precision and effectiveness of the consolidation process. Intelligent accommodation of the distinct attributes of both the first and second material threads ensures the formation of a robustly bonded consolidated composite thread 102, with the consolidation process tailored to the individual characteristics of each material. In some embodiments, the moveable wall is configured to narrow the cross-sectional area of the channel between the entrance 110E and the exit 110X. In other embodiments, the moveable wall is configured to broaden the cross-sectional area of the channel between the entrance 110E and the exit 110X.

In some embodiments, the movable wall 114 includes a densifying mechanism assembly 118A, 118B configured to enhance the density of the consolidated composite thread 102. The densifying mechanism assembly 118A, 118B applies controlled conditions, such as pressure to the threads to minimize voids and ensure a uniform, densely packed composite. FIG. 1 illustrates an embodiment where springs load the thread fusion enclosure plates 112A, 112B, providing a movable wall 114 in the channel 110. As the movable wall 114 narrows the cross-sectional area of the channel, these thread fusion enclosure plates 112A, 112B exert pressure on the threads, encouraging them to compact and align, resulting in a denser consolidated composite thread 102.

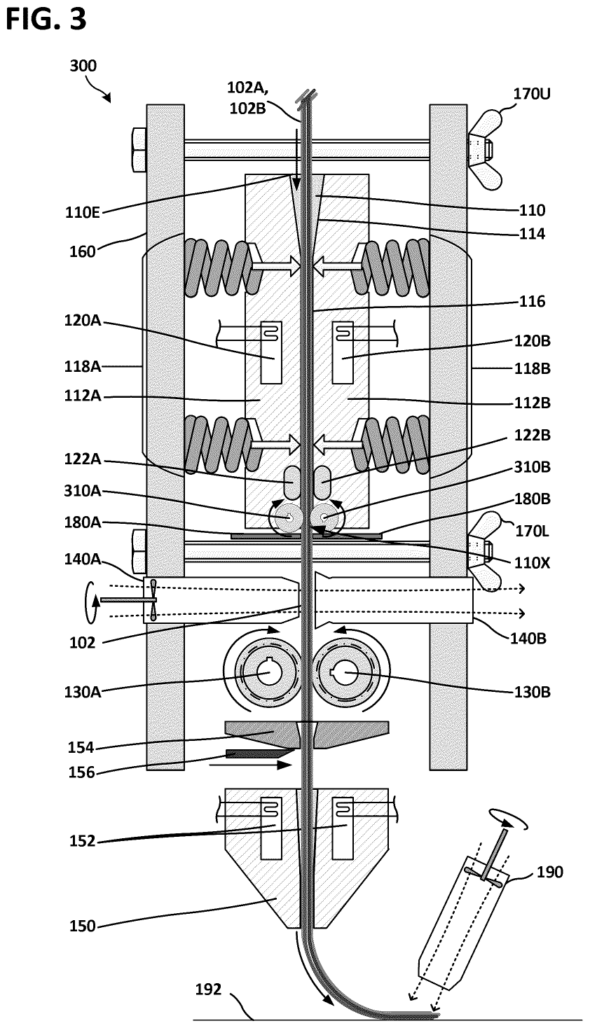

In another embodiment, the densifying mechanism assembly 118A, 118B includes compression rollers. For example, FIG. 3 illustrates an embodiment of a thread conditioning device with a void eliminator 310A, 310B that fills cross-sectional void regions of the one or more threads of the first material 102A with the second material. The void eliminators 310A, 310B, depicted as compression rollers in the void eliminator arrangement 300, are located inside the channel 110 or in proximity to the exit 110E. These void eliminators 310A, 310B provide controlled compression of the threads effectively filling cross-sectional void regions with the second material 102B. The adjustable pressure exerted by the rollers aids in achieving optimal consolidation, as well as improving interlayer adhesion between the first material 102A and the second material 102B.

The void eliminator mechanism can encompass various designs tailored to achieve effective consolidation. In some embodiments, the void eliminators 310A, 310B correspond to pressure plates, which apply consistent and adjustable pressure to the consolidated composite thread 102 as it progresses through the channel. In some embodiments, the void eliminators 310A, 310B correspond to compression pads, positioned to press against the threads and ensure thorough integration of the second material. In some embodiments, the void eliminators 310A, 310B correspond to inflatable bladders within the channel, allowing precise pressure control to ensure optimal material distribution and consolidation. These versatile embodiments highlight the adaptability of the void eliminator concept to diverse consolidation scenarios, enhancing interlayer adhesion and promoting uniformity in the resultant consolidated composite thread 102.

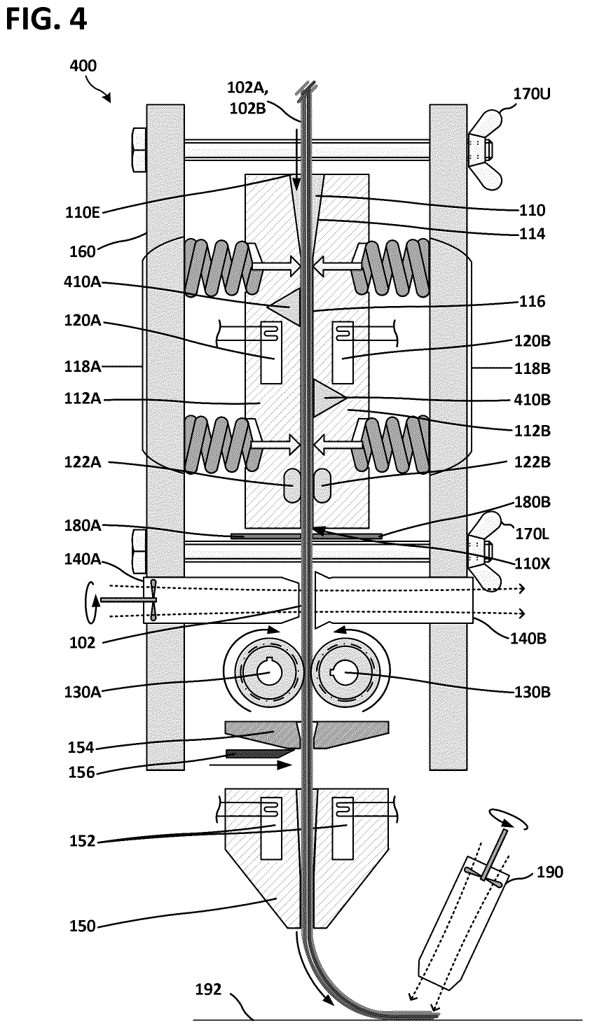

Some embodiments of the densifying mechanism assembly 118A, 118B include homogenizers 410A, 410B. For example, the homogenizer arrangement 400 of FIG. 4 illustrates an embodiment of a thread conditioning device with homogenizers 410A, 410B that emit sonic, ultrasonic, or mechanical vibrations along the channel 110. The placement of homogenizers 410A, 410B along the channel 110 can be asymmetric, with homogenizer 410A situated at a different location compared to homogenizer 410B. Alternatively, in some embodiments, homogenizers 410A, 410B are symmetrically positioned along the channel 110, with both situated along the same location of the channel 110. These homogenizers 410A, 410B can induce localized heat and pressure, facilitating molecular bonding between the first material 102A and the second material 102B. Further, the sonic, ultrasonic, or mechanical vibrations aid in aligning the threads, promoting better interlocking between the first material 102A and the second material 102B.

In some embodiments, the densifying mechanism assembly 118A, 118B includes pneumatic pistons configured to exert varying degrees of pressure on the threads. This controlled compression contributes to the removal of voids and ensures uniform consolidation. In some embodiments, the densifying mechanism assembly 118A, 118B includes a screw-driven mechanism such as stepper motors, which provides for gradual and precise compression of the threads. This mechanism enables precise adjustments to achieve the desired degree of densification. In some embodiments, the densifying mechanism assembly 118A, 118B includes hydraulic systems to exert substantial force on the threads, which can be regulated to optimize densification without compromising the integrity of the threads. In some embodiments, densifying mechanism assembly 118A, 118B includes electromagnets to produce magnetic fields to manipulate the orientation of particles within the threads, further aiding in alignment and consolidation.

In certain embodiments, the densifying mechanism assembly 118A, 118B is equipped with a compression regulator, such as the incorporation of springs attached to the thread fusion enclosure plates 112A, 112B. This compression regulator governs the level of applied pressure exerted upon the one or more threads of the first material 102A and the one or more threads of the second material 102B. The compression regulator provide precise and adjustable control over the compression process and enables optimization of the consolidation process by effectively tailoring the pressure exerted on the threads, contributing to void elimination, uniform densification, and the enhancement of interlayer bonding between the first material 102A and the second material 102B.

To enhance the monitoring and control of the consolidation process, the device integrates one or more density sensors 122A, 122B, as depicted in FIG. 1, that are specifically designed to measure the density of the composite, which include the individual threads of the first material 102A and the second material 102B within the confines of the channel 110. These density sensors 122A, 122B provide feedback on the density distribution and homogeneity of the consolidated threads, contributing to the overall quality, uniformity, and consistency of the resulting consolidated composite thread 102. Continuous monitoring of the density of the thread materials enables the device to maintain the desired structural integrity and mechanical properties throughout the consolidation process, ensuring the production of high-performance composite materials with precision and reliability.

Various types of density sensors 122A, 122B can be employed to measure the density of the consolidated composite thread 102 within the channel 110. Examples include X-ray densitometers, gamma ray densitometers, ultrasonic density sensors, laser-based density sensors, capacitance-based density sensors, and optical density sensors. These sensors utilize different principles, such as radiation absorption, sound wave propagation, light scattering, and electrical capacitance, to determine the density of materials. Each type of density sensor has its unique advantages and applications, offering a range of options for accurate density measurement in the consolidation process.

In certain embodiments, the thread conditioning device integrates process monitor sensors that are intricately linked with various components of the device. An array of process monitor sensors can be implemented, encompassing temperature sensors like thermocouples, thermistors, and infrared sensors, pressure sensors including strain gauges and piezoelectric sensors, flow rate sensors, humidity sensors, displacement sensors such as linear variable differential transformers (LVDTs), position sensors like encoders, and viscosity sensors. These sensors deliver real-time data on critical parameters, enabling meticulous control and adjustment of the consolidation process.

Furthermore, these sensors in specific embodiments are interlinked with at least one of the heaters 120A, 120B, the thermal conditioner 140A, 140B, and the driver 130A, 130B. Collaborating seamlessly with the process monitor sensors is an adaptive controller, intricately connected to these sensors. This adaptive controller is meticulously configured to dynamically fine-tune and adjust the pressure parameters of the densifying mechanism assembly 118A and 118B. This dynamic adjustment is guided by instantaneous feedback received from the process monitoring sensors, ensuring that the consolidation process remains precise, adaptive, and exquisitely responsive to real-world conditions.

As depicted in FIG. 1, the thread conditioning device further incorporates one or more heaters 120A, 120B that are thermally interconnected with the channel 110. These heaters serve to elevate the temperature of the one or more threads of the first material 102A and the one or more threads of the second material 102B beyond the melting temperature, Tm, of the second material 102B, leading to the fusion of the second material 102B with the one or more threads of the first material 102A. It is important to note that the melting temperature, Tm, of the second material 102B might not have a singular precise value. Instead, certain polymers (such as amorphous polymers, crystalline polymers, semi-crystalline polymers, etc.) can exhibit a melting temperature, Tm, that spans a temperature range or corresponds to a temperature within or above the glass transition temperature, Tg.

The incorporated heaters 120A, 120B within the thread conditioning device can be equipped with integrated sensors that facilitate the detection of the generated heat at the source of the heater itself. These integrated sensors provide real-time feedback on the temperature achieved by the heaters during operation and directly monitor the heat generated at the heater source. This enhances the overall accuracy of the fusion and thermal conditioning procedure.

In conjunction with the integrated sensors in the heaters, the thread conditioning device features a driver 130A, 130B designed to propel the one or more threads of the first material 102A and the one or more threads of the second material 102B through the channel 110, and push the consolidated composite thread 102 through the severing nozzle 154 and the extruder nozzle 150 to the proper position of the 3D printed object 192. This driver mechanism ensures controlled and continuous advancement of the threaded materials, precisely regulating their movement through the consolidation process. Harmonizing the data obtained from the integrated sensors in the heaters with the propulsion actions of the driver enables a synchronized and adaptive process that optimizes material fusion. Coordination between temperature control and material advancement results in the creation of the consolidated composite thread 102 with superior mechanical properties and structural integrity.

The driver 130A, 130B depicted in FIG. 1 features a set of rollers, where one or both of these rollers are motor-driven. This arrangement serves to advance the one or more threads of the first material 102A and the one or more threads of the second material 102B through the channel 110 and out the extruder nozzle 150 in a controlled manner. The motor-driven rollers ensure consistent and synchronized movement, facilitating the precise fusion of the threaded materials. Beyond the roller-based driver of FIG. 1, various other driver mechanisms can be implemented to achieve the same objective. For example, in some embodiments a belt-driven system, a screw-driven mechanism, or a linear motor arrangement is employed to propel the threads along the channel, ensuring optimal consolidation and subsequent extrusion of the consolidated composite thread 102.

Notably, the driver 130A, 130B advances the consolidated composite thread 102 through the channel 110 and also effectively pushes and guides the consolidated composite thread 102 into the severing nozzle 154. The severing nozzle 154 includes a tapering channel that directs the consolidated composite thread 102 towards the extruder nozzle 150. Positioned after the end of the tapering channel within the severing nozzle 154 is the severing blade 156, which is part of a blade assembly configured to cut the consolidated composite thread 102. The blade assembly includes a blade with an edge designed to sever the consolidated composite thread 102, and an actuator mechanism that is operably connected to the severing blade 156. This actuator mechanism is configured to engage the severing blade 156 in response to a cutting signal, allowing the severing blade 156 to sever the consolidated composite thread 102 with minimal disruption to its direction or flow. The severing operation is performed in a manner similar to a guillotine, ensuring a clean and efficient cut. After the severing operation, the consolidated composite thread 102 maintains its direction from the severing nozzle 154 to the extruder nozzle 150.

In some embodiments, the severing nozzle 154 is distinct from the extruder nozzle 150, functioning as a separate unit to perform the severing operation before the thread reaches the extruder. In other embodiments, the severing nozzle 154 is integrated with the extruder nozzle 150, combining the cutting and extrusion processes into a single assembly. Notably, the severing nozzle 154 is thermally insulated from the extruder nozzle 150, either by an air gap or a thermally insulative material, to ensure precise control over the severing process and to maintain the integrity of the thread during its transition between the two nozzles.

Importantly, the severing nozzle 154 is thermally insulated from the extruder nozzle 150. This thermal insulation is achieved either by an air gap or a thermally insulative material, ensuring that the heat from the extruder nozzle 150 does not affect the performance or longevity of the severing nozzle 154 or the consolidated composite thread 102.

In some embodiments, the severing blade 156 is located at the exit of the severing nozzle 154, as depicted in FIGS. 1-8, where the distance between this point and the extruder nozzle 150 should be considered to ensure accurate cutting length and placement. In some embodiments, the severing blade 156 is positioned at the exit of the extruder nozzle 150, which simplifies precise control over the cutting location, directly at the point where the composite material is extruded.

In some embodiments, the severing blade 156 operates in a guillotine-like manner, moving to slice through the consolidated composite thread 102 cleanly. This design provides a robust cutting action with minimal deflection of the material. In some embodiments, the severing blade 156 operates as a rotary cutter, where a circular blade rotates to sever the thread. This embodiment offers a continuous cutting action, which could be beneficial for high-speed operations. In some embodiments, the severing blade 156 operates as a scissor-like mechanism, where two blades move towards each other to cut the thread with a shearing action.

Once the consolidated composite thread 102 enters the extruder nozzle 150, it encounters extruder heaters 152 that reheat the 102 consolidated composite thread 102, rendering it pliable and ready for deposition onto the 3D printed object 192. These extruder heaters 152 carefully adjust the temperature to ensure the consolidated composite thread 102 reaches the desired state for effective deposition. As the pliable consolidated composite thread 102 is deposited onto the 3D printed object 192, the cooling fan 190 of the extruder nozzle 150, is activated. This cooling fan 190 reduces the temperature of the consolidated composite thread 102, causing it to solidify and fuse to the surface of the object. This final solidification stage ensures the proper adhesion and integrity of the consolidated composite thread 102 onto the object, creating a structurally sound and resilient finished product.

The thread conditioning device further incorporates a thermal conditioner 140A, 140B situated between the driver 130A, 130B and the exit 110X of the channel 110. The primary objective of the thermal conditioner 140A, 140B, is to cool the consolidated composite thread 102, specifically the second material 102B, to a temperature below its melting point subsequent to the consolidation phase within the channel 110. This cooling prevents the consolidated composite thread 102 from remaining in a softened or semi-molten state, which could make it difficult for the driver 130A, 130B to handle. Through this cooling procedure, the composite material attains a more solid form, streamlining its manageability. This enhanced solidity ensures that the driver 130A, 130B can efficiently propel and manipulate the consolidated composite thread 102 without encountering excessive pliability or undesired “gooeyness.”

The illustrative embodiment in FIG. 1 showcases the thermal conditioner 140A, 140B as a fan with a duct to move and direct the flow of air across the consolidated composite thread 102, thereby reducing the temperature of the consolidated composite thread 102 or the second material 102B below the melting temperature of the second material 102B prior to contact with the driver 130A, 130B. In some embodiments, the thermal conditioner 140A, 140B corresponds to a fan. In some embodiments, the thermal conditioner 140A, 140B corresponds to a passively air-cooled configuration, harnessing convection currents within the thread conditioning device to achieve the desired cooling effect on the consolidated composite thread 102 or the second material 102B.

Alternative embodiments of the thermal conditioner 140A, 140B extend beyond the fan and duct configuration. For instance, in some embodiments, a Peltier cooling devices is employed, utilizing thermoelectric principles to cool the consolidated composite thread 102 below the melting temperature of the second material 102B. In other implementations, a heat sink mechanism involving heat-absorbing materials is positioned adjacent to the channel 110 to dissipate excess heat from the consolidated composite thread 102. Another approach could involve the controlled release of a cooling fluid or gas within the vicinity of the consolidated composite thread 102 below the melting temperature of the second material 102B.

Thermal conditioning provides several distinct advantages by contributing to the precision and reliability of the consolidation process. Effective lowering of the temperature of the second material 102B below its melting point prevents unwanted distortion of the threaded materials. Controlled cooling ensures that the consolidation process occurs under optimal conditions, which enhances the bonding between the first material 102A and the second material 102B, resulting in a well-bonded consolidated composite thread 102.

Moreover, thermal conditioning promotes uniformity in the resulting consolidated composite thread 102. The reduction in temperature helps to maintain consistent material properties and structural integrity across the length of the consolidated composite thread 102. This uniformity translates into improved mechanical performance and reliability in the final product.

As depicted in the thread arrangement 100 of FIG. 1, the thread conditioning device includes a shape manipulator 180A, 180B positioned adjacent to the exit 110X of the channel, to influence the cross-sectional shape of the single consolidated composite thread 102 as it emerges. This shape manipulator 180A, 180B is designed to alter the configuration of both the one or more threads of the first material 102A and the second material 102B that exit the channel 110. The shape manipulator 180A, 180B imparts specific geometrical attributes to the consolidated composite thread 102 to enhance its structural characteristics for particular applications. The incorporation of a shape manipulator 180A, 180B at the exit 110X of the channel 110 is an optional feature, offering the flexibility to selectively modify the cross-sectional shape of the emerging consolidated composite thread 102.

The shape manipulator 180A, 180B can assume various embodiments. For instance, in some embodiments, the shape manipulator 180A, 180B corresponds to an adjustable pair of rollers that exert pressure on the consolidated composite thread 102 to reshape it. In some embodiments, the shape manipulator 180A, 180B corresponds to a set of movable plates that gently mold the consolidated composite thread 102 into the desired cross-sectional shape. In some embodiments, the shape manipulator 180A, 180B corresponds to a pneumatic system that uses controlled air pressure to shape the exiting thread. In some embodiments, the shape manipulator 180A, 180B corresponds to an electromagnet that exerts electromagnetic fields to influence the orientation of the thread materials and thus alter their cross-sectional configuration.

The shape manipulator 180A, 180B offers the flexibility to produce a variety of cross-sectional shapes for the consolidated composite thread 102. For example, it can create uniform circular shapes, ensuring consistent dimensions throughout the thread. Additionally, it has the capability to generate elliptical or oval shapes, allowing for increased surface area contact or specific directional characteristics. The shape manipulator can also mold the thread into rectangular or square profiles, suitable for applications requiring flat and even surfaces. The shape manipulator 180A, 180B can create intricate star-shaped cross-sections, adding points that provide unique mechanical interactions and enhanced gripping properties. It is also capable of producing oval shapes, elongating the cross-section of the thread for increased contact area. Triangular profiles offer stability and directional strength, making them suitable for specific load-bearing applications. For more complex applications, the shape manipulator can fashion polygonal cross-sections, such as hexagons or octagons, introducing additional facets for improved bonding between materials. These shape options open up possibilities for tailoring the properties of the single consolidated composite thread 102 to match diverse functional and structural requirements.

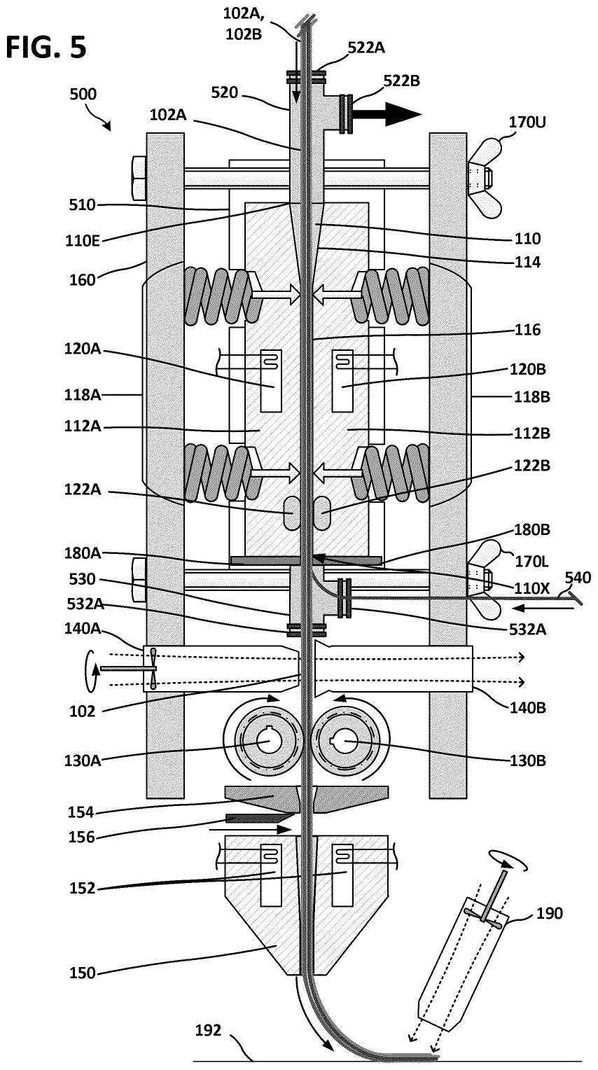

FIG. 5 Illustrates an embodiment of a vacuum enclosure 510 for the thread conditioning device. In the vacuum enclosure arrangement 500, the vacuum enclosure 510 is equipped with both an inlet 520 and an outlet 530, designed to accommodate a controlled suction force to aid in void removal from the consolidated composite thread 102. Suction is applied to the inline intake 522A or the adjacent intake 522B to the one or more threads of the first material 102A and the one or more threads of the second material 102B. The outlet 530 is structured to mitigate the ingress of air from of the suction. This outlet 520 provides for the inline exit 532A of the consolidated composite thread 102 while concurrently facilitating the adjacent intake 532B of a third material 540. In some embodiments, the third material 540 corresponds to the second material 102B, seamlessly aligning with the existing composite. In some embodiments, the third material 540 corresponds to a material with a strong affinity to the first material 102A, enhancing the cohesive properties of the consolidated composite thread 102. In some embodiments, the third material 540 corresponds to an adhesive that serves to enhance the bonding between the one or more threads of the first material 102A and the second material within the consolidated composite thread 102, resulting in improved cohesion and adhesion. In some embodiments, the third material 540 corresponds to reinforcement material to bolster the mechanical properties of the composite, adding strength, stiffness, or other desired characteristics. In some embodiments, the third material 540 corresponds to a filler material that efficiently fills voids and contributes to specific attributes of the consolidated composite thread 102, such as enhancing thermal conductivity or electrical properties. In some embodiments, the third material 540 corresponds to a functional additive that imparts distinct functionalities to the consolidated composite thread 102, such as UV resistance, flame retardance, or antimicrobial properties. In some embodiments, the third material 540 corresponds to a colorant used to add visual distinction to the consolidated composite thread 102, serving identification or aesthetic purposes. In some embodiments, the third material 540 corresponds to a phase change material (PCM) with the unique capability to absorb or release heat during phase transitions, making it advantageous for applications requiring precise thermal regulation. In some embodiments, the third material 540 corresponds to nanostructure materials that offer exceptional properties to the consolidated composite thread 102, such as enhanced conductivity, catalytic activity, or optical effects.

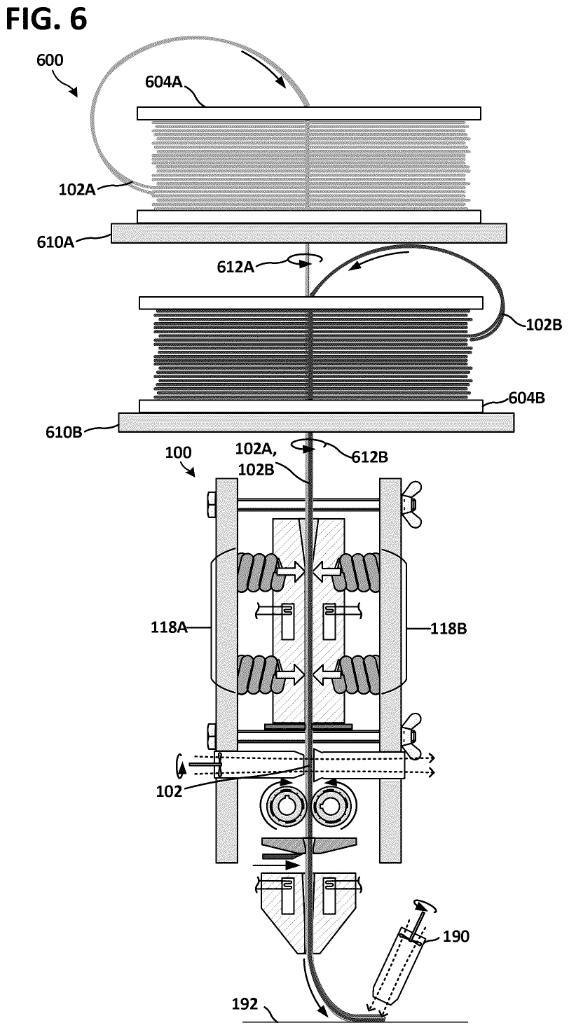

FIG. 6 Illustrates an embodiment of a thread conditioning device with a thread tensioner 610A, 610B. As depicted in the thread tensioner arrangement 600 of FIG. 6, the thread tensioners 610A, 610B are positioned prior to the entrance 110E of the channel 110. The tensioners 610A, 610B are designed to impart a first twist 612A in the one or more threads of the first material 102A and a second twist 612B in the one or more threads of the second material 102B. These twists 612A, 612B provide a way to tune the wetting process of the second material within the threads of the first material 102A. That is, these twists 612A, 612B orient the second material within the one or more threads of the first material 102A to provide an inside-out wetting process that displaces voids that may exist between the threads. As a result, the integration of materials within the consolidated composite thread 102 can be tuned.

Notably, the embodiment allows for variations in the characteristics of the twist: the same or opposite rotational directions, as well as different rotational speeds, can be utilized for the first twist 612A and second twist 612B, according to the specific requirements of the consolidation process. These adaptability features ensure that the thread tensioners 610A, 610B optimally contribute to the precise and controlled fabrication of the consolidated composite thread 102 with varying material combinations and properties. In some embodiments, the one or more threads of the first material 102A and the one or more threads of the second material 102B are twisted together prior to entering the channel 110. In some embodiments, the first twist 612A of the one or more threads of the first material 102A corresponds to the same rotational direction of the second twist 612B of the one or more threads of the second material 102B. In some embodiments, the first twist 612A of the one or more threads of the first material 102A corresponds to the opposite rotational direction of the second twist 612B of the one or more threads of the second material 102B. In some embodiments, the rotational speed of the first twist 612A of the one or more threads of the first material 102A corresponds to the same rotational speed of the second twist 612B of the one or more threads of the second material 102B. In some embodiments, the rotational speed of the first twist 612A of the one or more threads of the first material 102A corresponds to a faster rotational speed of the second twist 612B of the one or more threads of the second material 102B. In some embodiments, the rotational speed of the first twist 612A of the one or more threads of the first material 102A corresponds to a slower rotational speed of the second twist 612B of the one or more threads of the second material 102B.

Although not depicted, it is contemplated that in some embodiments, the one or more threads of the first material 102A and the one or more threads of the second material 102B are woven prior to entering the channel 110. The weave could encompass various patterns and configurations, offering tailored consolidated composite thread 102 characteristics. For instance, a plain weave might involve an over-under pattern, where each thread of the first material alternates passing over and under each thread of the second material, creating a consistent and balanced structure. Alternatively, a twill weave could be employed, where the threads interlace in a diagonal pattern, providing enhanced strength and durability. Moreover, a satin weave might be used, featuring fewer interlacings, resulting in a smoother and more pliable consolidated composite thread 102. These weaving variations contribute to the mechanical properties, texture, and appearance, of the composite allowing for versatility in achieving specific performance and aesthetic outcomes.

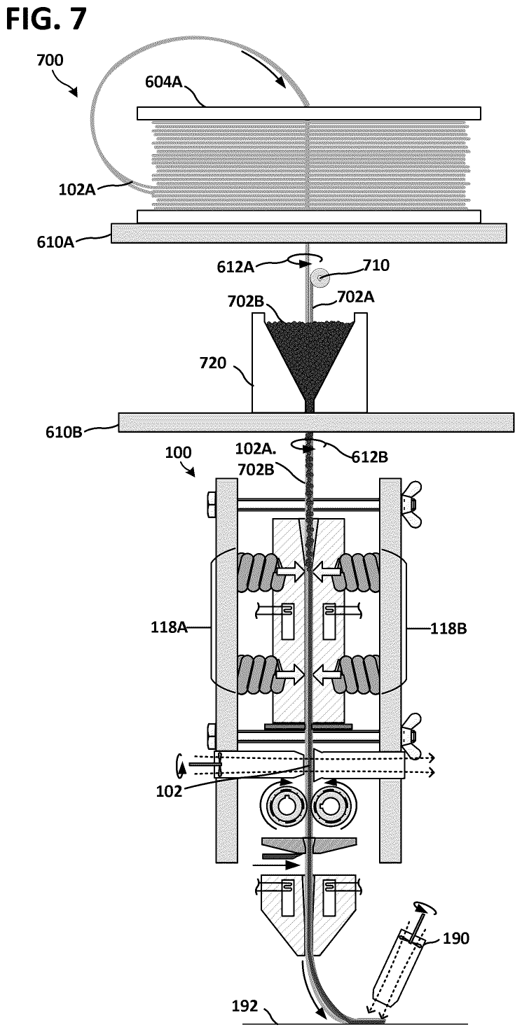

FIG. 7 Illustrates an embodiment of a thread conditioning device with a dispenser 720 that applies particles of a second material onto the one or more threads of a first material. As depicted in the dispenser arrangement 700 of FIG. 7, the first tensioner 610A imparts a first twist 612A to the one or more threads of the first material 102A, while the dispenser 720 positioned on the second tensioner 610B effectively dispenses particles of a second material onto the one or more threads of the first material 102A.

Notably, this configuration highlights the dynamic functionality of the first tensioner 610A. In some embodiments, the first tensioner 610A rotates to facilitate adherence of the particulates 702 of the second material onto the one or more threads of the first material 102A. As depicted in FIG. 7, the dispenser 720 corresponds to a taper shape where the one or more threads of the first material 102A traverses through its openings. As a result, the particulates 702 of the second material are seamlessly integrated with the threads, enhancing the structural integrity of the single consolidated composite thread 102.

It should be appreciated that various alternative designs of the dispenser can be employed to achieve effective material application onto the threads. In some embodiments, the dispenser 720 corresponds to a nozzle-like dispenser that releases controlled amounts of the second material particles 702 onto the threads as they pass through. This technique ensures precision in particle distribution. In some embodiments, the dispenser 720 corresponds to a rotating drum dispenser with particle reservoirs, where the rotation of the rotating drum dispenser aligns the reservoir openings with the threads to release particles at specific intervals. In some embodiments, the dispenser 720 corresponds to a vibrating tray dispenser, which uses controlled vibrations to disperse particles onto the threads evenly. These diverse dispenser designs offer flexibility in particle application methods, enabling tailored adjustments based on the desired consolidated composite thread 102 characteristics and applications.

The dispenser arrangement 700 of FIG. 7 further includes applicator 710 that introduces an element to aid in increasing the adherence of the particulates 702 to the one or more threads of the first material 102A. In some embodiments, the element introduced by the applicator 710 corresponds to an electrostatic charge applied to either the one or more threads of the first material 102A or to the particles 702B creating an attractive force that draws the particles towards the threads and improves their adherence. This electrostatic interaction can be precisely controlled to optimize particle coverage. In some embodiments, and the particles 702B are electrically charged in the reverse polarity to the electrostatic charge of the one or more threads of the first material 102A. In some embodiments, the element introduced by the applicator 710 corresponds to an adhesive material applied to either the one or more threads of the first material 102A or to the particles 702B. This adhesive enhances the binding between the particles and the threads, promoting better cohesion and long-lasting integration within the consolidated composite thread 102.

In some embodiments, the element introduced by the applicator 710 corresponds to a binder applied to either the one or more threads of the first material 102A or to the particles 702B. The binder helps bind the particulates to the threads more effectively. In some embodiments, the element introduced by the applicator 710 corresponds to a flux applied to either the one or more threads of the first material 102A or to the particles 702B. The flux enhances the fusion and cohesion of the particulates with the threads. In some embodiments, the element introduced by the applicator 710 corresponds to a curing agent applied to either the one or more threads of the first material 102A or to the particles 702B. The curing agent expedites the curing process and strengthens the adherence. In some embodiments, the element introduced by the applicator 710 corresponds to a surface modifier applied to either the one or more threads of the first material 102A or to the particles 702B. The surface modifier adjusts the surface properties of the threads or particles to create a more favorable environment for particulate adhesion. In some embodiments, the element introduced by the applicator 710 corresponds to a charging agent applied to either the one or more threads of the first material 102A or to the particles 702B. The charging agent enhances the electrostatic attraction between the particulates and thread. In some embodiments, the element introduced by the applicator 710 corresponds to a micro-encapsulated additives applied to either the one or more threads of the first material 102A or to the particles 702B. The micro-encapsulated additives burst upon contact within the channel 110, releasing substances that aid in adhesion. In some embodiments, the element introduced by the applicator 710 corresponds to a heat treatment applied to either the one or more threads of the first material 102A or to the particles 702B. The heat treatment slightly soften the threads or particles 702B, making them more receptive to the particulate. In some embodiments, the element introduced by the applicator 710 corresponds to a solvent applied to either the one or more threads of the first material 102A or to the particles 702B. The solvent temporarily softens the threads, allowing the particulates to adhere more effectively.

It is also contemplated that in alternative embodiments, the consolidation process could involve pre-impregnation. Instead of introducing one or more threads of the second material 102B or particles 702 into the composite, at least one thread of the first material 102A could be coated with the second material that has the ability to reflow and fuse during the consolidation process. This pre-impregnation approach offers a more integrated consolidated composite thread 102 structure, potentially enhancing uniformity and eliminating the need for additional material insertion steps.

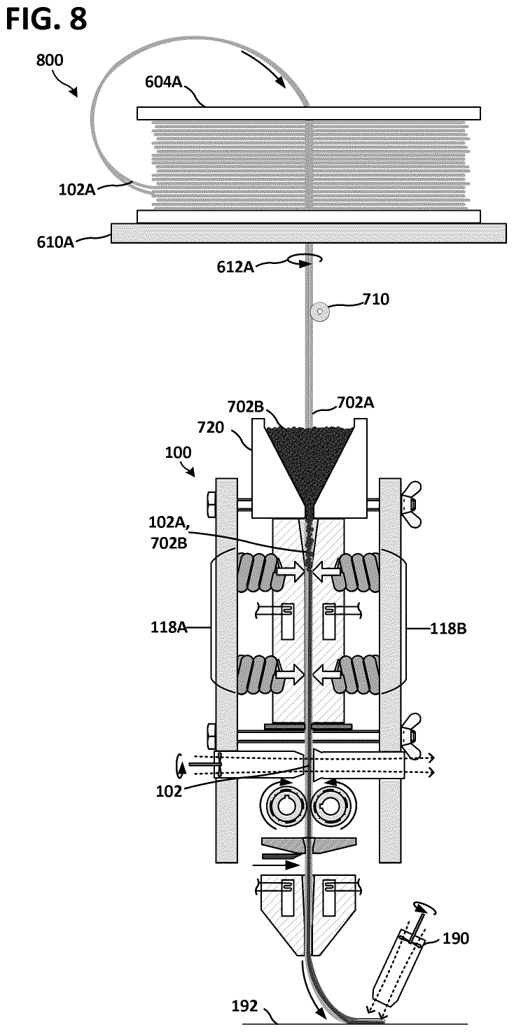

FIG. 8 Illustrates an embodiment of a thread conditioning device with a dispenser 720 that introduces a second material directly into the channel. In the dispenser arrangement 800 depicted in FIG. 8, the second tensioner 610B is omitted, and the dispenser 720 is positioned directly adjacent to the entrance 110E of the channel 110. The dispenser 720 introduces particles of the second material into the channel and onto the one or more threads of the first material 102A as they enter the channel 110.

This arrangement, while similar to the setup in FIG. 7, presents a distinct advantage in terms of material delivery. Eliminating the second tensioner 610B allows for more immediate and closely synchronized incorporation of the second material with the consolidation process. The proximity of the dispenser 720 to the channel entrance ensures seamless integration of the introduced particles with the threads, thus enhancing the efficiency and cohesion of the consolidation process.

In some embodiments, the dispenser 720 is separable into two distinct components. This split design facilitates easier threading of the one or more threads of the first material 102A during initial setup and convenient cleaning and maintenance of the dispenser system. This design consideration adds a layer of practicality, streamlining operational processes and contributing to the overall user-friendliness of the device.

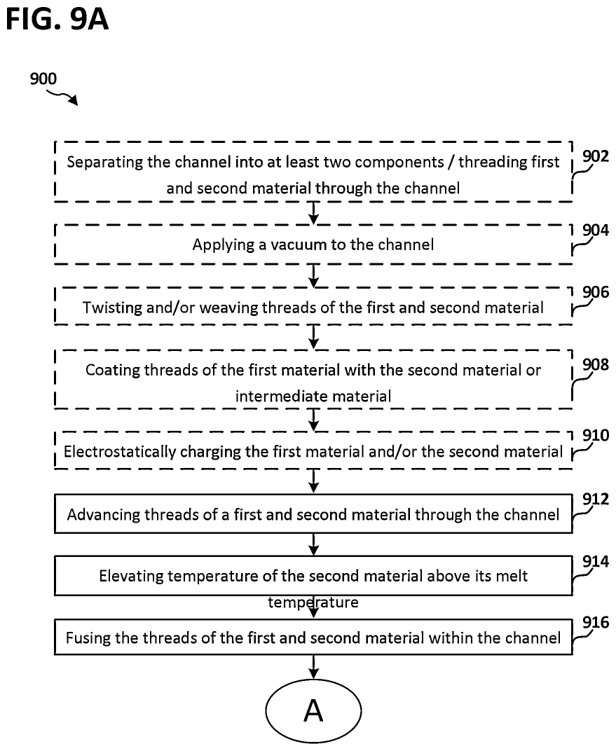

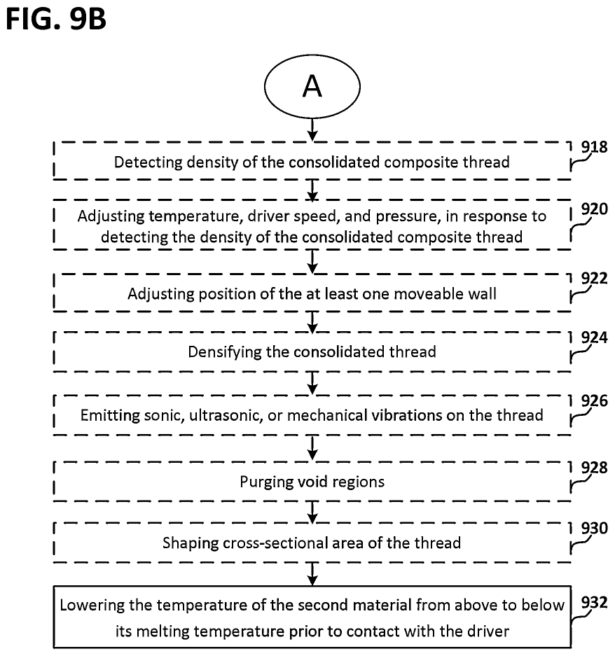

FIGS. 9A-9B Illustrate an exemplary flow diagram for consolidating one or more first material 102A threads and the second material. Process 900 provides for merging one or more first material 102A threads and the second material into a single consolidated thread composite 102 in accordance with some embodiments. In some embodiments, the process 900 is performed by the channel 110 of the thread fusion enclosure plates 112A, 112B. Some operations in process 900 may be combined, the order of some operations may be changed, and some operations may be omitted.

At operation 902, process 900 optionally separates the channel 110 into at least two components along a length of the channel from an entrance of the channel to an exit of the channel 110. As depicted in FIG. 2, the enclosure plates 112A, 112B are separable along the channel 110 length. Separating the channel 110 eases the process of threading the first material and the second material into the channel 110. The separation of the channel 110 into distinct components further facilitates maintenance such as when the channel 110 becomes clogged or repaired.

Some embodiments, implement a detachable thread fusion enclosure plates 112A, 112B, where the channel is divided into at least two components. Such an embodiment streamlines initial loading by enabling independent manipulation of the first and second materials, enhancing precision and advantageous for maintenance, allowing easy access for cleaning in case of clogging or residue buildup. Some embodiments implement an adjustable channel 110 configuration, where the distance between the channel walls can be modified to accommodate different thread sizes and configurations. This adaptability ensures efficient threading and consolidation of threads with varying properties.

At operation 904, process 900 optionally applies a vacuum to the channel 110. A vacuum further facilitates the elimination of residual voids or air pockets within the consolidated composite thread 102. FIG. 5 depicts a vacuum enclosure 510 equipped with both an inlet 520 and an outlet 530. Creating a controlled vacuum environment within the channel 110, draws out any remaining voids, ensuring that the first material and the second material are brought into close contact and securely bonded. This vacuum-assisted consolidation is useful in applications where maximum consolidation and homogeneity are desired, as it offers an effective means of achieving superior material integration and overall thread quality.

In some embodiments, a vacuum enclosure surrounds the channel 110, equipped with inlet 520 and outlet 530 ports, similar to FIG. 5. The controlled suction force exerted through the inlet engages with the composite threads, effectively removing air voids and promoting better material compaction. Some embodiments, implement a vacuum-assisted impregnation process, where the channel 110 is initially evacuated, creating a low-pressure environment. Subsequently, the second material is introduced, and the change in pressure encourages its penetration into the voids between the threads. Some embodiments implement a segmented channel 110 with alternating vacuum and pressure regions, dynamically controlling the material flow and densification process. These embodiments collectively underscore the versatility of vacuum-assisted consolidation techniques in achieving superior consolidated composite thread 102 performance through efficient void removal and enhanced material integration.

At operation 906, process 900 optionally twists and/or weaves threads of the first and second material. The twisting and weaving introduce specific orientations and patterns into the threads, reinforcing their bond and improving their overall performance. For instance, referring to the configuration depicted in FIG. 6, the first thread tensioner 610A and the second thread tensioner 610B serve as examples of twisting together one or more threads of the first material with one or more threads of the second material. This twisting action imparts an arrangement that enhances material adherence during the consolidation process.

Furthermore, FIGS. 7 and 8 offer insight into variations of these twisting techniques. In both scenarios, the first thread tensioner 610A imparts twisting to the one or more threads of the first material. In FIG. 7, the second thread tensioner 610B is eliminated, and the twisting is conducted solely on the one or more threads of the first material. In FIG. 8, the twisting of the one or more threads of the first material takes place directly before their introduction into the channel, ensuring their optimal arrangement prior to consolidation. These twisting and weaving approaches provide tailored enhancements to the structural integrity, mechanical properties, and overall performance of the consolidated composite thread 102.

At operation 908, process 900 optionally, coats the at least one thread of the first material with the second material. This alternative approach aims to augment the amalgamation of materials within the consolidated composite thread 102. That is, rather than introducing particles of the second material directly onto the threads, this method involves the application of a coating of the second material onto at least one thread of the first material to penetrate the interstices between the threads during the consolidation process.

In some embodiments, at least one of the one or more threads of the first material are initially coated with the second material before entering the consolidation process. This method ensures an even distribution of the second material within the composite, enhancing cohesion and minimizing voids.

Process 900 of the optional step at operation 908 further coats at least one thread of the first material with an intermediate material. Various types of intermediate materials can be employed, each tailored to its specific role. For instance, adhesive intermediates are designed to promote a secure bond between the first and second materials, enhancing their cohesion throughout the consolidation. Moreover, functional intermediates can confer specific attributes, such as UV resistance, thermal stability, or antimicrobial properties, thus imbuing the consolidated composite thread 102 with diverse functionalities. Additionally, structural intermediates, like reinforcing fibers, impart mechanical durability to the composite, elevating its overall robustness.

In some embodiments, the intermediate bonding material is coated onto one or both the first and second materials. This intermediate material acts as a bridge, enhancing adhesion and promoting strong bonding between the materials, ultimately contributing to the densification process. In some embodiments, the coating has a constant thickness. In some embodiments, the coating is a gradient coating. For gradient coating, the second material is coated onto the threads of the first material in a way that creates a gradient concentration along the length of the thread. This gradient coating can be achieved through controlled deposition techniques, such as vapor deposition or electroplating. The varying concentration of the second material along the length of the thread imparts unique properties to different sections of the consolidated composite thread 102. For instance, a higher concentration of the second material at one end of the thread could enhance adhesion and consolidation in that region, while a lower concentration towards the other end could facilitate flexibility or other desired characteristics.

At operation 910, process 900 optionally electrostatically charges the first material and/or the second material. When the first material and/or the second material are subjected to an electrostatic charge, an attractive force is generated that draws the materials closer together. This electrostatic interaction not only increases the affinity between the materials but also aids in their uniform distribution and integration within the consolidated composite thread 102. Electrostatically charging the materials provides a controlled and precise approach to material alignment, ensuring optimal consolidation and minimizing the presence of voids or weak spots. This technique proves particularly valuable in achieving thorough material intermingling, resulting in enhanced structural integrity and performance of the consolidated composite thread 102 for various applications.

The incorporation of electrostatic charges within the consolidation process introduces a range of versatile embodiments that contribute to the enhanced integration and bonding of materials. In some embodiments, a dual-polarity electrostatic charges, where opposite charges are applied to the first and second materials. This generates an attractive force between the materials, ensuring a robust bond and efficient consolidation. Some embodiments implement a graduated electrostatic charging, which enables customization of material adhesion along the length of the thread, offering varying levels of consolidation based on specific requirements. Some embodiments implement pulsed electrostatic charging, which introduces intermittent application of charges, promoting dynamic material movement and thorough mixing during consolidation. In some embodiments, selective electrostatic charging is implemented, which offers the ability to focus consolidation on critical regions, while variable electrostatic charging adapts charge densities in real-time to compensate for any inconsistencies. These embodiments can be implemented by introducing electrodes or charge applicators along the path of the materials, positioned to apply charges as required. Sensors and feedback mechanisms can monitor material alignment and trigger adjustments to the charge parameters.

At operation 912, process 900 advances threads of the first and second material through the channel 110. This can be observed in several illustrative embodiments depicted in FIGS. 1-8. The driver 130A, 130B applies controlled motion to the threads, propelling them forward within the channel 110. Various mechanisms, such as a motorized system, pulleys, or other mechanical means, depending on the specific configuration, can achieve this movement of the driver 130A, 130B. Utilizing the driver 130A, 130B to navigate the threads through the channel ensures a continuous and uniform flow of materials, which leads to an evenly consolidated and integrated consolidated composite thread 102. This driver-guided advancement maintains precision and consistency in the placement and distribution of materials, ultimately contributing to the structural robustness and performance of the resultant consolidated composite thread 102.

Several alternative techniques can be employed to advance the advances threads of the first and second material through the channel 110. For example, some embodiments implement magnetic propulsion with embedded magnetic particles that respond to magnetic fields, propelling the threads forward and enhancing their integration. Some embodiments implement ultrasound-guided movement, which utilizes acoustic forces to vibrate the threads, promoting their progression while improving material interactions. Some embodiments implement capillary action, which takes advantage of the natural affinity between materials and channel walls to draw the threads through the channel. Some embodiments implement piezoelectric stimulation, which induces vibrations within the channel, facilitating material advancement through mechanical impulses. Some embodiments implement fluid flow assistance, which introduces controlled fluid dynamics to generate a hydrodynamic force that propels the threads forward. Some embodiments implement electromagnetic induction, which employs induced currents in the threads when exposed to an electromagnetic field, resulting in directed movement along the channel. Some embodiments implement a thermal gradient within the channel, which induces expansion or contraction in the threads, harnessing temperature-induced dimensional changes to guide their progression. Some embodiments implement ionic propulsion, which leverages threads impregnated with ions, responding to an electric field within the channel to drive the movement.

At operation 914, process 900 elevates the temperature of the second material above its melting temperature. The thread conditioning device, as depicted in FIGS. 1-5, incorporates one or more heaters 120A, 120B designed to provide controlled heating to the consolidated composite thread 102. Careful temperature adjustment brings the second material to a molten state, enabling it to flow and infuse between the threads of the first material. The application of heat also conditions the thread for the removal of voids or air pockets that may be present within the composite. As the second material melts and fills these interstitial spaces, the overall density and homogeneity of the consolidated composite thread 102 are improved. The one or more heaters are positioned to ensure uniform heating, preventing localized overheating or uneven material distribution.

In some embodiments, electromagnetic induction technology is employed, utilizing coils or elements within the thread conditioning device to generate localized heat directly within the consolidated composite thread 102. This precise heating method ensures that the second material reaches its molten state with minimal energy loss and maximum efficiency. In some embodiments, radiant heaters or infrared sources are utilized that emit thermal energy in a controlled manner to elevate the temperature of the second material.

At operation 916, process 900 fuses the threads of the first and second material within the channel 110. This fusion is a result of both the controlled confinement of the threads within the channel 110 and the heating applied to elevate the second material above its melting point, as described in earlier stages of the process. The design of the channel, with its precise dimensions and close fit to the consolidated composite thread 102, also facilitates ensures that the threads are held tightly in place during the consolidation process.

As the second material transitions into a molten state due to the elevated temperature, it gains fluidity and the ability to flow. The close confines of the channel 110 create a natural constraint on the movement of the threads, channeling the molten second material to infuse between the interstices of the threads of the first material. This phenomenon is akin to the threads becoming encapsulated within a controlled environment that fosters their integration and bonding. The combination of confined space and molten state drives the threads to merge, fuse, and adhere together as the second material re-solidifies within the interstitial spaces upon cooling.

At operation 918, process 900 optionally detects the density of the consolidated composite thread 102. The one or more density sensors 122A, 122B, as illustrated in the thread conditioning device depicted in FIGS. 1-5, can detect the density of the consolidated composite thread 102. These density sensors are strategically placed along the process route to measure density variations within the consolidated composite thread 102. Detecting the density of the consolidated composite thread 102 provides valuable insights into its structural integrity, homogeneity, and overall quality. Measuring density at specific points along the length of the thread allows the process to identify areas of potential concern, such as regions with inconsistent material distribution, voids, or areas with compromised consolidation. Information gathered by the one or more density sensors 122A, 122B can be used to make real-time adjustments to the process parameters, ensuring that the consolidation process is optimized and that the resulting consolidated composite thread 102 meets the desired specifications.

The integration of one or more density sensors, such as the density sensors 122A, 122B shown in FIGS. 1-5, introduces a range of versatile embodiments to enhance the thread conditioning process. These density sensors can be strategically positioned at various points along the channel or the thread pathway to monitor and assess the density distribution within the consolidated composite thread 102. Additionally, the optional detection of density serves as a quality control measure, allowing for the identification of defects or irregularities that might arise during the consolidation process. Addressing these issues promptly helps minimize material waste, enhance production efficiency, and ultimately yield composite threads with superior mechanical properties and performance characteristics.

In some embodiments, a density sensor is located immediately after the exit 110X of the channel 110, effectively measuring the density of the consolidated composite thread 102 as it emerges from the consolidation process. This enables real-time feedback on the success of the consolidation and provides insights into potential defects or irregularities that might have occurred during the process. The density sensors can be designed to emit and receive signals that penetrate the consolidated composite thread 102, allowing them to accurately gauge its density and internal structure.

In some embodiments, density sensors are placed at multiple locations along the thread pathway within the channel 110, as depicted in FIG. 4. This approach allows for a comprehensive assessment of density variations throughout the entire length of the consolidated composite thread 102. Comparing density measurements at different points enables the process to pinpoint specific regions that might require further consolidation or adjustments to the process parameters. These density sensors can utilize a range of technologies, such as ultrasound, X-ray, or even optical methods, to achieve accurate and reliable density measurements.

At operation 920, process 900 optionally adjusts temperature, driver speed, and pressure, in response to detecting the density of the consolidated composite thread 102. The data collected by the density sensors can be processed and analyzed in real-time, providing valuable feedback to the control system of the thread conditioning device. Based on this feedback, the process parameters, such as temperature, pressure, or material flow rates, can be adjusted dynamically to optimize the consolidation process. This responsive approach ensures that the resulting consolidated composite thread 102 meets the desired density specifications, resulting in improved structural integrity and performance characteristics for various applications.

This responsive approach capitalizes on the data gathered from the density sensors to optimize the process parameters in real-time. For instance, if a density sensor detects an area of the consolidated composite thread 102 with lower than desired density, the system can automatically increase the temperature, adjust the speed of the driver, or modify the applied pressure. These adjustments are made with a high degree of accuracy, ensuring that the consolidation process is fine-tuned to achieve uniform density distribution throughout the consolidated composite thread 102.

Harnessing this closed-loop feedback mechanism ensures that any potential inconsistencies or voids are promptly addressed during the consolidation process. For example, if a section of the consolidated composite thread 102 exhibits higher density than intended, adjustments can be made to prevent over-consolidation, which could lead to reduced material properties or unwanted distortion. Real-time optimization enables the production of composite threads with the desired density profile, enhancing their overall structural integrity and performance for a wide range of applications.

At operation 922, process 900 optionally adjusts the position of the at least one moveable wall 114. This dynamic adjustment allows for fine-tuning the channel dimensions during the consolidation process. Altering the position of the moveable wall 114 modifies the cross-sectional area of the channel 110, affecting the flow dynamics of the composite materials. Such adjustments can have a significant impact on the consolidation outcome, influencing factors like material distribution, density, and overall thread quality. The ability to regulate the position of the moveable wall 114 in response to real-time feedback or predetermined parameters enhances the versatility and control of the thread conditioning device, resulting in tailored composite threads with optimized properties for various applications.

The concept of a moveable wall 114 within the channel 110 of the thread conditioning device presents various embodiments to enhance the consolidation process. The moveable wall 114 can be implemented as a flexible element or a set of adjustable plates (e.g., thread fusion enclosure plates 112A, 112B), allowing for changes in the geometry of the channel 110. In some embodiments, the moveable wall 114 includes a series of interlocking plates that can be shifted horizontally to modify the width of the channel 110. In other embodiments, the moveable wall 114 consists of a flexible membrane that can expand or contract based on the desired cross-sectional area. This adjustment mechanism may be manual, controlled by an operator, or automated, with the position altered based on real-time data from sensors detecting parameters such as material flow rate or density. Enabling the dynamic alteration of the channel dimensions provides an innovative approach to tailor the consolidation process according to specific material characteristics and desired thread properties, resulting in superior performance of the consolidated composite thread 102.

At operation 924, process 900 optionally densifies the consolidated thread. This densification process can be realized through the implementation of a densifying mechanism assembly 118A, 118B, such as the one depicted in FIGS. 1-5, where loaded springs apply controlled pressure on the consolidated composite thread 102. The loaded springs are positioned to exert compressive force on the thread as it exits the channel 110 to compact the materials and removing any remaining voids or gaps between them. The adjustable nature of the loaded springs (e.g., via wing-nuts 170U, 170L) allows for precise control over the applied pressure, enabling customization based on material characteristics and desired thread properties. This operation contributes to the improved cohesion of the materials within the consolidated composite thread 102 and aids in the overall consolidation process by minimizing porosity and enhancing density. The densifying mechanism assembly ensures a uniform and consistent thread structure, reinforcing its mechanical strength and making it well-suited for a wide range of applications.

Various embodiments can be employed at operation 924 to achieve the densification of the consolidated thread, each offering unique approaches to enhance the structural integrity and overall quality of the thread. In some embodiments, the densifying mechanism assembly 118A, 118B includes a pneumatic or a hydraulic system, to exert controlled pressure on the thread, resulting in effective material compaction. These systems can be integrated into the thread conditioning device and adjusted to apply varying levels of pressure based on the specific requirements of the materials being used. In some embodiments, specialized tools or attachments are introduced to the thread conditioning device to physically manipulate and compress the thread as it exits the channel 110. This could involve rollers, presses, or other mechanical devices designed to ensure uniform pressure distribution along the length of the thread. These diverse embodiments provide flexibility in achieving optimal densification, catering to different material compositions and desired thread characteristics. Ultimately, the chosen densification approach can be tailored to the specific application and requirements, resulting in composite threads with enhanced mechanical properties, reduced void content, and improved performance.

At operation 926, process 900 optionally emits sonic, ultrasonic, or mechanical vibrations on the consolidated thread. This operation can be executed using specialized devices such as homogenizers 410A, 410B, positioned along the channel 110 as illustrated in FIG. 4. Sonic and ultrasonic vibrations, when directed onto the consolidated composite thread 102, generate mechanical waves that propagate through the material. These waves induce localized movement and agitation, helping to break up any remaining air pockets or voids within the thread. The mechanical vibrations generated by these devices create a dynamic environment that encourages the redistribution of particles and enhances the interlocking of materials, resulting in a more uniform and homogenous consolidated composite thread 102. These vibrations can be controlled in terms of frequency, intensity, and duration to suit the specific characteristics of the materials being used. Incorporating this optional operation allows the process to address potential weaknesses or inconsistencies in the consolidation of the thread, ultimately contributing to improved structural integrity and performance in various applications.

At operation 928, process 900 optionally purges void regions with the consolidated thread. Purging void regions is achieved through the utilization of components generally referred to as “void eliminators,” to ensure a thorough purging of voids and/or air pockets within the consolidated composite thread 102. These void eliminators 310A, 310B, as depicted in FIG. 3, can be positioned either within the channel 110 itself or in proximity to the exit 110X of the channel 110, enabling efficient void removal.

The function of the void eliminators 310A, 310B is to apply controlled compression to the threads of the composite as they exit the channel 110. This compression effectively forces any trapped air or voids out of the thread, resulting in a denser and more homogenous final product. In some embodiments, the void eliminators 310A, 310B are compression rollers that exert adjustable pressure on the threads. Controlled application of pressure allows the void eliminators 310A, 310B to displace any voids that may have formed during the consolidation process.

The positioning of the void eliminators 310A, 310B, whether inside the channel 110 or at its exit 110X, ensures that void regions are systematically addressed, contributing to the enhancement of the composite structural integrity of the thread. This optional step provides an additional level of refinement to the consolidation process, resulting in a higher-quality final product with improved density and minimized inconsistencies.

The implementation of this embodiment involves integrating the void eliminators 310A, 310B into the thread conditioning device, either within the architecture of the channel or at a strategic location near the exit. The compression pressure applied by the void eliminators 310A, 310B can be adjusted based on the specific materials and thread characteristics, contributing to optimal void removal without damaging the thread itself. The utilization of void eliminators 310A, 310B ensures that the consolidated thread is as void-free and uniform as possible, meeting the desired specifications for various applications.

In some embodiments, the void eliminators 310A, 310B are pneumatic bladders, placed within the channel or at its exit, which can be inflated with controlled air pressure to gently compress the consolidated composite thread 102 and expel trapped air, all without causing damage to the thread itself. In some embodiments, the void eliminators 310A, 310B are ultrasonic vibration devices, emitting ultrasonic vibrations onto the consolidated composite thread 102 to dislodge and evacuate void regions. In some embodiments, the void eliminators 310A, 310B are vacuum-assisted components, where controlled vacuum environments near the exit 110X of the thread aids in the removal of trapped air. In some embodiments, the void eliminators 310A, 310B are rotating brush mechanisms. In some embodiments, the void eliminators 310A, 310B are pneumatic pistons. In some embodiments, the void eliminators 310A, 310B are sonic wave generators. In some embodiments, the void eliminators 310A, 310B are mechanical flattening mechanisms.

At operation 930, process 900 optionally shapes cross-sectional area of the consolidated composite thread 102. The shape manipulator 180A, 180B, as depicted in FIGS. 1-5 adjusts the geometry of the composites thread 102 to meet specific requirements. Embodiments of the shape manipulator vary in design and function, providing a range of options for shaping the cross-sectional area of the thread. For instance, by altering the gap distance between shape manipulator 180A, 180B, the width and height of the thread can be adjusted, allowing for the creation of threads with rectangular or even triangular cross-sections. Moreover, variations in the curvature and orientation of the shape manipulator 180A, 180B components can result in threads with more intricate and specialized shapes, such as star patterns or asymmetric geometries. This operation is particularly useful when tailoring composite threads for applications with specific structural, mechanical, or functional requirements. As the consolidated composite thread 102 emerges from the channel 110, the shape manipulator 180A, 180B imparts a refined cross-sectional shape, effectively influencing the behavior and properties of the thread in alignment with the desired outcome. This level of precision in shaping further highlights the thread conditioning adaptability and versatility of the device in producing composite threads optimized for a myriad of applications.

In some embodiments, the shape manipulator 180A, 180B correspond to adjustable plates that are moved closer or farther apart to modify the width and height of the emerging thread, enabling the creation of rectangular or square cross-sectional profiles. In such embodiments the plates are planar or contoured to guide the thread to adopt intricate shapes, such as ellipses or curves, as it exits the channel 110. In some embodiments, the shape manipulator 180A, 180B correspond to a set of rotating rollers, each with a unique profile, allowing the thread to be shaped as it passes through the gaps of the rollers. Furthermore, a patterned mold embedded within the shape manipulator 180A, 180B can impart intricate surface patterns or textures onto the thread. These diverse embodiments enable precise control over the cross-sectional geometry of the thread, making it possible to achieve threads with tailored shapes that are optimized for specific applications, whether it is to enhance mechanical properties, facilitate interlocking structures, or provide unique functionalities.

At operation 932, process 900 optionally lowers the temperature of the second material from above its melting temperature to below its melting temperature prior to contact with the driver 130, 132. This temperature adjustment can be executed using the thermal conditioner 140A, 140B depicted in FIGS. 1-5. The thermal conditioner 140A, 140B cools the consolidated composite thread 102 below the melting temperature of the second material after it has been elevated to its molten state, thereby solidifying it. The solidification of the second material achieved through the thermal conditioner 140A, 140B enables the driver 130A, 130B to securely grip the consolidated composite thread 102 for advancing the threads through the channel 110 and further guiding it through the channel of the extruder nozzle 150. This solidification ensures that the consolidated composite thread 102 maintains its shape and structure as it is propelled through the consolidation and thermal conditioning process. The 132 interaction of the driver 130 with the solidified thread allows for precise control and movement, ensuring that the characteristics of the consolidated composite thread 102 are maintained throughout the entire process.

The above description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other embodiments. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed under 35 U.S.C § 112(f) unless the element is expressly recited using the phrase “means for.”

1. A device, comprising:
a channel with an entrance and an exit, wherein the entrance is configured to receive one or more threads of a first material and one or more threads of a second material;
one or more heaters thermally coupled to the channel, wherein the one or more heaters are configured to elevate a temperature of the second material above a melting temperature of the second material;
a driver for advancing the one or more threads of the first material and the one or more threads of the second material through the channel; and
a thermal conditioner interposed between the driver and the exit of the channel, wherein the thermal conditioner is configured to reduce the temperature of the second material below the melting temperature of the second material.

2. The device of claim 1, wherein the channel is further configured to consolidate the one or more threads of the first material and the one or more threads of the second material into a single consolidated thread.

3. The device of claim 2, further comprising:
a void eliminator located inside or adjacent to the channel, wherein the void eliminator is configured to fill cross-sectional void regions of the single consolidated thread with the second material.

4. The device of claim 2, further comprising:
a blade assembly positioned after the exit of the channel, wherein the blade assembly includes:
a blade having an edge designed to cut the single consolidated composite thread after it exits the channel; and
an actuator mechanism operably connected to the blade to control its movement, wherein the actuator mechanism is configured to engage the blade in response to a cutting signal, thereby severing the single consolidated composite thread with minimal disruption to direction or flow of the single consolidated composite thread.

5. The device of claim 1, wherein the channel is further configured to separate into at least two components along a length of the channel from the entrance of the channel to the exit of the channel.

6. The device of claim 1, wherein the channel further includes at least one moveable wall.

7. The device of claim 6, wherein the at least one moveable wall is configured to narrow or broaden a cross-sectional area of the channel between the entrance and the exit.

8. The device of claim 6, further comprising:
a densifying mechanism assembly connected to the at least one moveable wall, wherein the densifying mechanism assembly is configured to densify the one or more threads of first material and the one or more threads of the second material.

9. The device of claim 8, wherein the densifying mechanism assembly includes a compression regulator configured to control pressure applied to the one or more threads of the first material and the one or more threads of the second material.

10. The device of claim 8, further comprising:
one or more sensors operatively coupled to at least one or more of the heaters, the channel, the thermal conditioner, and the driver; and
an adaptive controller operatively coupled to the one or more sensors, wherein the adaptive controller is configured to adjust one or more of pressure parameters of the densifying mechanism assembly, a set point temperature of one or more heaters, and speed of the driver based on real-time feedback received from the one or more sensors.

11. The device of claim 1, wherein the one or more threads of the first material and the one or more threads of the second material are twisted together or woven together prior to entering the channel.

12. The device of claim 1, further comprising:
a homogenizer operatively coupled to the channel, wherein the homogenizer is configured to emit sonic, ultrasonic, or mechanical vibrations to the one or more threads of the first material and the second material while densifying.

13. A device, comprising:
a channel with an entrance and an exit, wherein the entrance is configured to receive one or more threads of a first material, and wherein at least one thread of the first material is coated with a second material capable of reflow;
one or more heaters thermally coupled to the channel, wherein the one or more heaters is configured to elevate a temperature of the second material above a melting temperature of the second material;
a driver for advancing the one or more threads of the first material through the channel; and
a thermal conditioner interposed between the driver and the exit of the channel, wherein the thermal conditioner is configured to reduce the temperature of the second material below the melting temperature of the second material.

14. The device of claim 13, wherein the channel is further configured to consolidate the one or more threads of the first material and the second material into a single consolidated thread.

15. The device of claim 14, further comprising:
a void eliminator located inside or adjacent to the channel, wherein the void eliminator is configured to fill cross-sectional void regions of the single consolidated thread with the second material.

16. The device of claim 14, further comprising:
a blade assembly positioned after the exit of the channel, wherein the blade assembly includes:
a blade having an edge designed to cut the single consolidated composite thread after it exits the channel; and
an actuator mechanism operably connected to the blade to control its movement, wherein the actuator mechanism is configured to engage the blade in response to a cutting signal, thereby severing the single consolidated composite thread with minimal disruption to direction or flow of the single consolidated composite thread.

17. The device of claim 13, wherein the channel is further configured to separate into at least two components along a length of the channel from the entrance of the channel to the exit of the channel.

18. The device of claim 13, wherein the channel further includes at least one moveable wall.

19. The device of claim 18, wherein the at least one moveable wall is configured to narrow or broaden a cross-sectional area of the channel between the entrance and the exit.

20. The device of claim 18, further comprising:
a densifying mechanism assembly connected to the at least one moveable wall, wherein the densifying mechanism assembly is configured to densify the one or more threads of first material and the second material.

21. The device of claim 20, wherein the densifying mechanism assembly includes a compression regulator configured to control pressure applied to the one or more threads of the first material and the second material.

22. The device of claim 20, further comprising:
one or more sensors operatively coupled to at least one or more of the heaters, the channel, the thermal conditioner, and the driver; and
an adaptive controller operatively coupled to the one or more sensors, wherein the adaptive controller is configured to adjust one or more of pressure parameters of the densifying mechanism assembly, a set point temperature of one or more heaters, and speed of the driver based on real-time feedback received from the one or more sensors.

23. The device of claim 13, wherein the one or more threads of the first material are twisted together or woven together prior to entering the channel.

24. The device of claim 13, further comprising:
a thread tensioner positioned before the entrance of the channel, wherein the thread tensioner is configured to twist the one or more threads of the first material.

25. The device of claim 13, further comprising:
a homogenizer operatively coupled to the channel, wherein the homogenizer is configured to emit sonic, ultrasonic, or mechanical vibrations to the one or more threads of the first material and the second material while densifying.

26. A device, comprising:
a channel with an entrance and an exit, wherein the entrance is configured to receive one or more threads of a first material;
a dispenser connected adjacent to the entrance of the channel, wherein the dispenser is configured to introduce a second material into the channel to coat the one or more threads of the first material;
one or more heaters thermally coupled to the channel, wherein the one or more heaters are configured to elevate a temperature of the second material above a melting temperature of the material;
a driver for advancing the one or more threads of the first material through the channel; and
a thermal conditioner interposed between the driver and the exit of the channel, wherein the thermal conditioner is configured to reduce the temperature of the second material below the melting temperature of the second material.

27. The device of claim 26, wherein the channel is further configured to consolidate the one or more threads of the first material and the second material into a single consolidated thread.

28. The device of claim 27, further comprising:
a void eliminator located inside or adjacent to the channel, wherein the void eliminator is configured to fill cross-sectional void regions of the single consolidated thread with the second material.

29. The device of claim 27, further comprising:
a blade assembly positioned after the exit of the channel, wherein the blade assembly includes:
a blade having an edge designed to cut the single consolidated composite thread after it exits the channel; and
an actuator mechanism operably connected to the blade to control its movement, wherein the actuator mechanism is configured to engage the blade in response to a cutting signal, thereby severing the single consolidated composite thread with minimal disruption to direction or flow of the single consolidated composite thread.

30. The device of claim 26, wherein the channel is further configured to separate into at least two components along a length of the channel from the entrance of the channel to the exit of the channel.

31. The device of claim 26, wherein the channel further includes at least one moveable wall.

32. The device of claim 31, wherein the at least one moveable wall is configured to narrow or broaden a cross-sectional area of the channel between the entrance and the exit.

33. The device of claim 31, further comprising:
a densifying mechanism assembly connected to the at least one moveable wall, wherein the densifying mechanism assembly is configured to densify the one or more threads of first material and the second material.

34. The device of claim 33, wherein the densifying mechanism assembly includes a compression regulator configured to control pressure applied to the one or more threads of the first material and the second material.

35. The device of claim 33, further comprising:
one or more sensors operatively coupled to at least one or more of the heaters, the channel, the thermal conditioner, and the driver; and
an adaptive controller operatively coupled to the one or more sensors, wherein the adaptive controller is configured to adjust one or more of pressure parameters of the densifying mechanism assembly, a set point temperature of one or more heaters, and speed of the driver based on real-time feedback received from the one or more sensors.

36. The device of claim 26, wherein the one or more threads of the first material are twisted together or woven together prior to entering the channel.

37. The device of claim 26, further comprising:
a homogenizer operatively coupled to the channel, wherein the homogenizer is configured to emit sonic, ultrasonic, or mechanical vibrations to the one or more threads of the first material and the second material while densifying.

38. The device of claim 26, wherein the one or more threads of the first material are electrostatically charged, and wherein the second material introduced by the dispenser is electrically charged in the reverse polarity to the electrostatic charge of the one or more threads of the first material.
